(19) United States
(12) Patent Application Publication
(10) Pub. No.: US 2007/0263884 A1
(43) Pub. Date: Nov. 15, 2007

(54) Audio Mixer Apparatus

(75) Inventor: James Carlton Bedingfield SR., Lilburn, GA (US)

Correspondence Address: MYERS BIGEL SIBLEY & SAJOVEC, P.A., P.O. BOX 37428, RALEIGH, NC, 27627, US

(73) Assignee: BellSouth Intellectual Property Corporation

(21) Appl. No.: 11/382,355

(22) Filed: May 9, 2006

(51) Int. Cl. H04B 1/00

(52) U.S. Cl. 381/119

(57) ABSTRACT

An audio mixer module is configured to receive audio input signals from audio input modules and to provide audio output signals to audio output modules. The audio mixer module may be configured to selectively mix the input audio signals to produce the respective audio output signals. The audio mixer module may be configured to support wireless and/or wireline audio signal coupling with the audio input modules and/or the audio output modules. The audio mixer module may be configured to provide analog and/or digital mixing of audio signals from the audio input modules.

### BACKGROUND

The present invention generally relates to audio electronics and, more particularly, to mixers for audio signals.

A wide variety of consumer electronics are capable of producing audio output signals and/or receiving audio input signals. Examples of such devices include CD and DVD players/recorders, personal computers, personal entertainment devices (e.g., Ipod®, mp3 player), microphones, speaker systems, stereos, home theater systems, and the like. In residential application, it is often desirable to be able to present audio output produced from such devices in a variety of different locations, e.g., in the kitchen, in the bedroom, in the workshop, on the deck, etc. There are a wide variety of systems for providing audio content throughout a home or other structure, with a typical system allowing a user to select a source, such as a radio or CD player, for distribution to one or more locations in and/or near the home.

Mixers are commonly used in recording studios, performance halls, arenas and other venues to allow audio signals from multiple sources to be combined to produce an audio output signal that includes a user-selected composition of the audio input signals. Such mixers may be used in concerts, for example, to provide a desired blend of signals from different musical instruments and/or performers. Such devices may have fixed signal input and output connections, e.g., fixed numbers and/or types of input and/or output jacks. Mixer functionality may also be provided in a computer. For example, the Volume Control utility provided in Windows® includes a mixer functionality that allows for the selective mixing of multiple audio sources.

### SUMMARY OF THE INVENTION

Some embodiments of the present invention provide an audio mixer module configured to receive audio input signals from audio input modules and to provide audio output signals to audio output modules. The audio mixer module may be configured to selectively mix the input audio signals to produce the respective audio output signals. The audio mixer module may be configured to support wireless and/or wireline audio signal coupling with the audio input modules and/or the audio output modules. The audio mixer module may be configured to provide analog and/or digital mixing of audio signals from the audio input modules.

In some embodiments, an audio mixer module may be configured to be mechanically support the audio input modules and/or the audio output modules. For example, in some embodiments, an audio mixer module may be configured to attach audio input modules and audio output modules thereto along respective substantially orthogonal directions. In other embodiments, audio input modules and audio input modules may be attached to a mixer module along a common direction. The mixer module may include a power supply circuit configured to be electrically coupled to audio input modules and/or the audio output modules attached thereto for provision of power to the audio input modules and/or audio output modules. An audio mixer module may include a plurality of user input devices configured to receive respective mixer command inputs and arranged in a two-dimensional array, wherein respective ones of the user input devices control coupling between respective pairs of audio input and audio output modules. The plurality of user input devices may include a plurality of arrayed physical Input devices and/or an array of input device representations depicted on a display. In other embodiments, the audio mixer module may be configured to receive mixer command inputs from a remote user input device.

Further embodiments of the present invention provide a residential audio mixer system flexibly configurable to receive audio input signals from a variety of residential audio sources and flexibly configurable to provide audio output signals to a variety of residential audio output devices. The residential audio mixer is configured to selectively mix the audio input signals to produce the respective audio output signal responsive to a mixer command input. The system may include a mixer module and a selection of audio input modules and/or audio input modules having various different external audio signal connection configurations and configured to interoperate with the mixer module. The mixer module may be configured to electrically and/or optically couple to and mechanically support audio input modules and/or audio output modules. The audio input modules and/or the audio output modules may include analog and/or digital signal processing circuitry configured to convert between a common signal format used by the audio mixer module and an external signal format.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE FIGURES

FIG. 1 is a schematic diagram illustrating a mixer apparatus according to some embodiments of the present invention.

FIG. 2 is a schematic diagram illustrating a modular analog mixer apparatus according to further embodiments of the present invention.

FIG. 3 is a schematic diagram illustrating an input module for a modular analog mixer apparatus according to some embodiments of the present invention.

FIG. 4 is a schematic diagram illustrating an output module for a modular analog mixer apparatus according to some embodiments of the present invention.

FIG. 5 is a schematic diagram illustrating volume control circuitry for an analog mixer apparatus according to some embodiments of the present invention.

FIG. 6 is a schematic diagram illustrating a modular digital mixer apparatus according to some embodiments of the present invention.

FIG. 7 is a schematic diagram illustrating an input module for a modular digital mixer apparatus according to some embodiments of the present invention.

FIG. 8 is a schematic diagram illustrating an output module for a modular digital mixer apparatus according to some embodiments of the present invention.

FIGS. 9 and 10 are schematic diagrams illustrating volume control circuitry for a digital mixer apparatus according to some embodiments of the present invention.

FIG. 11 is a schematic diagram illustrating a linearly arranged modular mixer apparatus according to further embodiments of the present invention.

FIG. 12 is a schematic diagram illustrating a modular mixer apparatus with a daisy-chained configuration according to further embodiments of the present invention.

FIG. 13 is a schematic diagram illustrating a modular mixer apparatus with a wireless configuration according to still further embodiments of the present invention.

### DETAILED DESCRIPTION OF EMBODIMENTS OF THE INVENTION

The present invention now will be described more fully hereinafter with reference to the accompanying figures, in which embodiments of the invention are shown. This invention may, however, be embodied in many alternate forms and should not be construed as limited to the embodiments set forth herein. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the term “and/or” includes any and all combinations of one or more of the associated listed items.

It will be understood that, when an element is referred to as being “coupled” to another element, it can be directly coupled to the other element or intervening elements may be present. In contrast, when an element is referred to as being “directly coupled” to another element, there are no intervening elements present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as methods, systems, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described below with reference to block diagram illustrations of methods, apparatus, and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

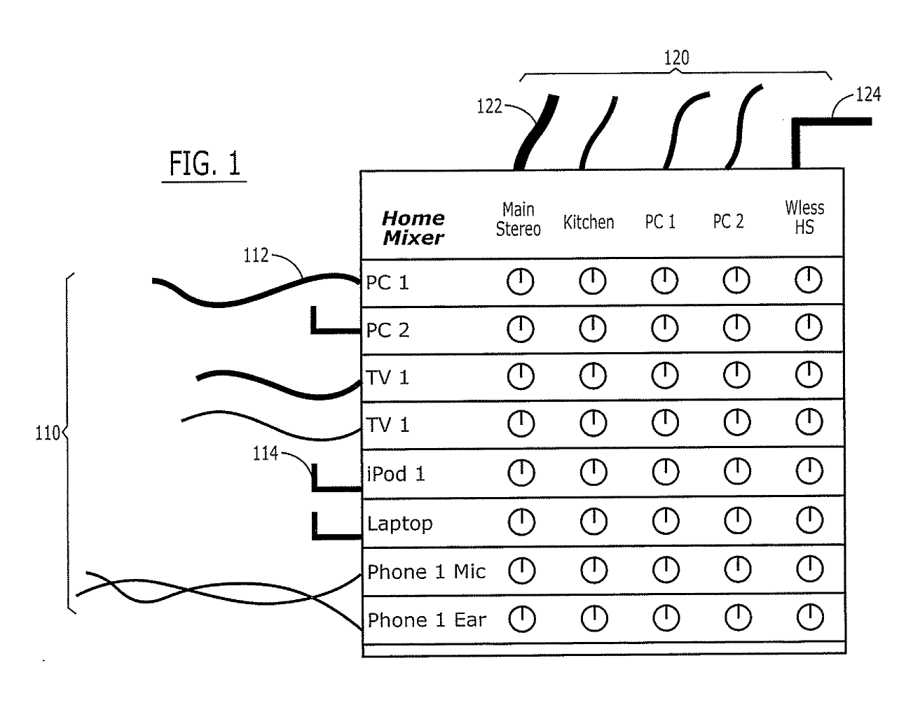

FIG. 1 illustrates a mixer apparatus 100 according to some embodiments of the present invention. The mixer apparatus 100 may, for example, be configured to be particular for residential use. The mixer apparatus 100 is flexibly configurable to receive a plurality of different types of audio inputs 110 from consumer electronic devices, such as personal computers, laptop computers, televisions, personal entertainment devices (e.g., IPod®), and microphones. The inputs 110 may include, for example, wireline inputs 112 and wireless (e.g., radio) inputs 114. The mixer apparatus 100 is further flexibly configurable to provide a plurality of different types of audio outputs 120 to various audio devices, such as stereo systems, room audio systems, personal computers, and wireless headsets. The audio outputs may include, for example, wireline outputs 122 and wireless (e.g., radio) outputs 124. The mixer apparatus 100 may be operative to selectively mix the audio inputs 110 to provide the respective audio outputs 120 responsive to, for example, mixer command inputs provided to user input devices (e.g., control knobs) 130.

Some embodiments of the present invention arise from a realization that application of a mixer to a residential or similar consumer applications may be enhanced by providing input and/or output structures that are flexibly configurable to be compatible with the wide variety of different types of signal formats used by consumer electronic devices and residential equipment. As used herein, “flexibly configurable” input and/or output structures are structures that allow a user (e.g., an installer, operator or the like) to select and modify the signal format, connection type, and other external interface characteristics of the inputs and/or outputs provided by the mixer apparatus, such that the apparatus may be configurable for use in a particular setting based on, for example, the types of devices that the user possesses and wishes to interface with the mixer apparatus.

According to some embodiments of the present invention, such flexible configurability of mixer inputs and/or outputs may be provided by modular mixer apparatus including a base mixer module that may be mated with input and/or output modules chosen from a selection of audio input modules and/or audio output modules that have different external signal formats and/or connection structures. Using such an arrangement in residential applications, for example, an installer (e.g., a homeowner and/or contractor) may select modules that are suited for the particular devices present at the residence. Reconfiguration of such a modular mixer apparatus may be achieved by adding, removing and/or substituting input and/or output modules.

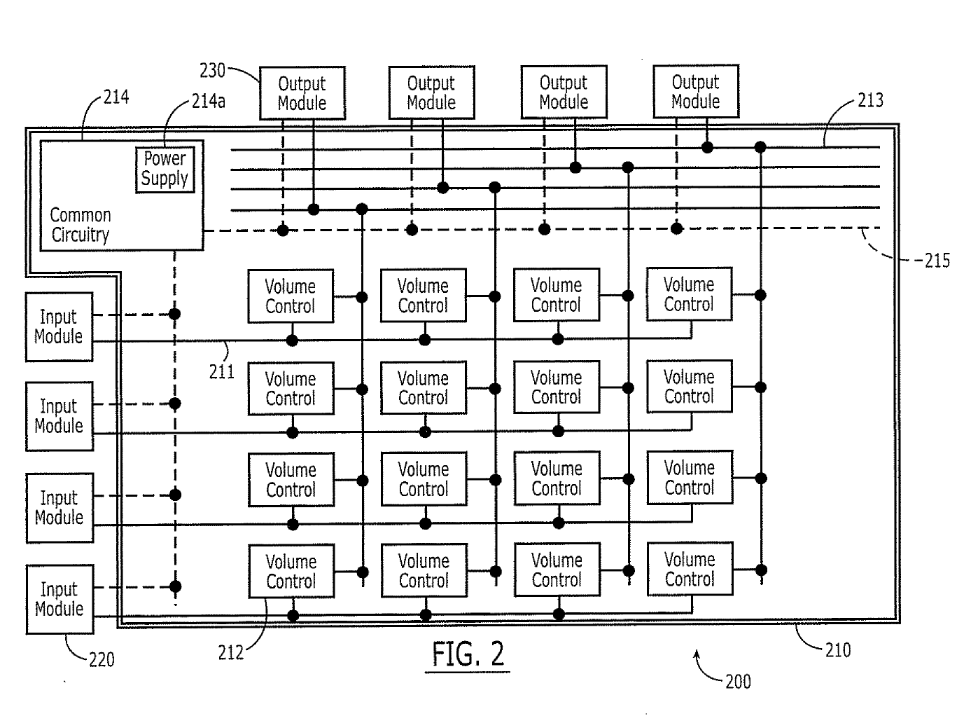

FIG. 2 illustrates a modular analog audio mixer apparatus 200 according to some embodiments of the present invention. The apparatus 200 includes a mixer module 210 that includes a plurality of audio input signal busses 211 that are configured to be coupled to audio input modules 220 and a plurality of audio output signal busses 213 that are configured to be coupled to a plurality of audio output modules 230. The mixer module 210 includes a plurality of mixer volume control circuits 212, respective ones of which are configured to selectively mix audio signals on the audio input signal busses 211 to produce respective audio output signals on the audio output signal busses 213. The input modules 220 may be configured to provide conversion between a signal format of an input device, e.g., a television, DVD player, PC or the like, and a common signal format used on the audio input signal busses 211. Similarly, the output modules 230 may provide signal conversion between a common signal format of the audio output signal busses 213 and signal formats used by various devices connected to outputs of the output modules 230.

The audio input modules 220 and/or the audio output modules 230 may, for example, be selectable from a collection (e.g., catalog) of different modules that are tailored for use with different external signal formats (e.g., wireless or wireless) and/or connection types (e.g., phono plugs of various sizes and configurations, RCA jacks, coax connectors, and/or blade connectors). In some embodiments, the input modules 220 and/or the output modules 230 may, for example, be configured to be mechanically attached to and supported by the mixer module 210, e.g., the modules 220, 230 may be designed to plug into, mount on or otherwise mechanically mate with the mixer module 210. In some embodiments, such as embodiments using cable and/or wireless links, mechanical support of the input modules 220 and/or the output modules 230 may not be required. In a given application, an installer (e.g., a homeowner and/or professional installer) may select various input modules 220 and/or output modules 230 suited for the application, and may appropriately mate the selected modules to the mixer module 200 to provide a desired connectivity. As shown, the mixer module 210 may further include common circuitry 214, such as a power supply 214a that is configured to provide power to the input modules 220 and/or the output modules 230 over a power bus 215.

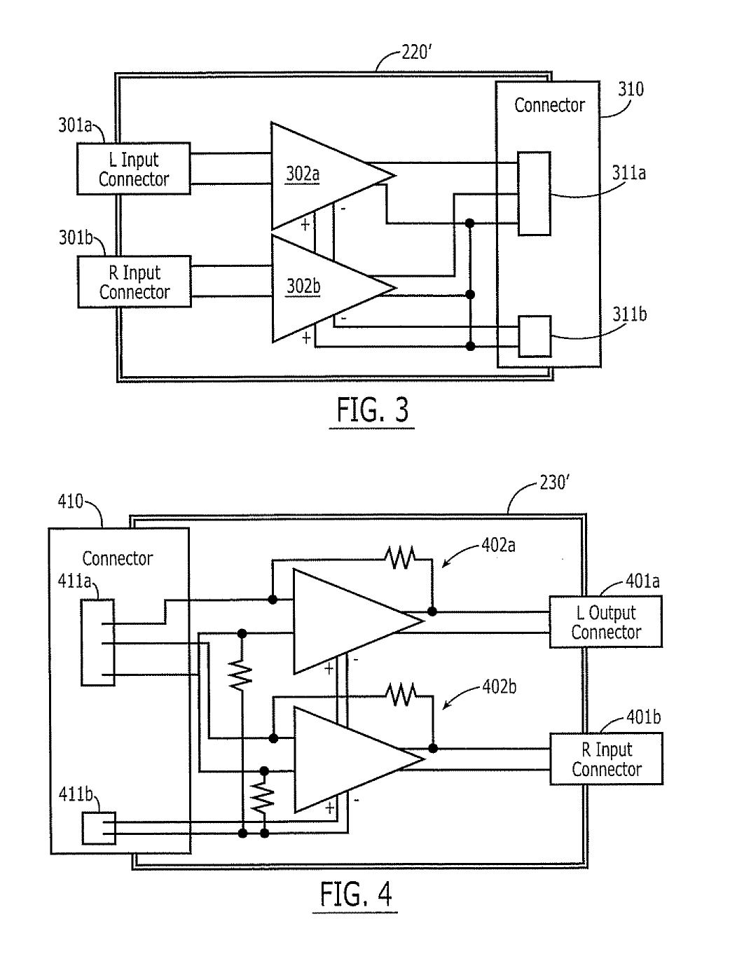

Referring to FIG. 3, an analog input module 220′ according some embodiments of the present invention may include, for example, first and second (e.g., left and right channel) input connectors 301a, 301b, which are connected to inputs of a first and second buffer amplifiers 302a, 302b. It will be appreciated that the stereo connectors 301a, 301b are merely examples, and that a particular input module may use any of a number of different types of input connections depending on the type of device to which the input module 220′ is to be connected. In general, a given input module may support single and/or multiple channels, and may utilize any of a number of different types of connections, e.g., phono plugs of various sizes and configurations, RCA plugs, blade connectors, terminal strips, wire clamps and the like.

Outputs of the buffer amplifiers 302a, 302b are connected to a connector 310 that is configured to mate with a base mixer module, e.g., the mixer module 210 of FIG. 2. As shown, the module connector 310 may include first pins, blades or other connector structures 311a configured to carry audio input signals produced by the buffer amplifiers 302a, 302b, and second pins, blades or other connector structures 311b configured to provide power connections for powering, for example, the buffer amplifiers 302a, 302b from a power source in the mixer module.

Referring to FIG. 4, an analog output module 230′ according to some embodiments of the present invention may be similarly configured. In particular, the output module 230′ may include a connector 410 that is configured to mate with a base mixer module, and includes first pins, blades or other connector structures 411a configured to provide audio output signal produced by the mixer module to buffer amplifiers 402a, 202b, and second pins, blades or other connector structures 411b configured to provide power connections for powering, for example, the buffer amplifiers 402a, 402b from a power source in the mixer module. Outputs of the buffer amplifiers 402a, 402b may be coupled to first and second output connectors 401a, 401b, which can be used to provide connection to an external device.

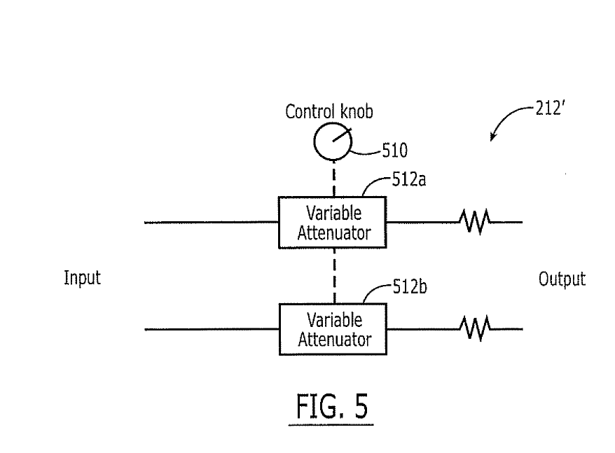

FIG. 5 illustrates a volume control circuit 212′ for an analog mixer module, such as the module 210 of FIG. 2, according to some embodiments of the present invention. The volume control circuit 212′ includes a control knob 510 (or other type of input device, such as a slider) that is configured to control variable attenuators 512a, 512b. For example, an attenuator 512a, 512b may comprise a variable resistor (potentiometer) that is configured to provide variable resistance between a given audio input bus 211 and a given audio output bus 213 (see FIG. 2) such that the combination of the attenuator 512a, 512b and the buffer amplifier of the output module connected thereto (see FIG. 4) acts as a summing amplifier that variably sums input signals thereto responsive to user input via the control knob 510. It will be appreciated that the circuit arrangements shown in FIGS. 2-5 are provided for purposes of illustration, and that other analog circuit arrangements may be used with other embodiments of the present invention.

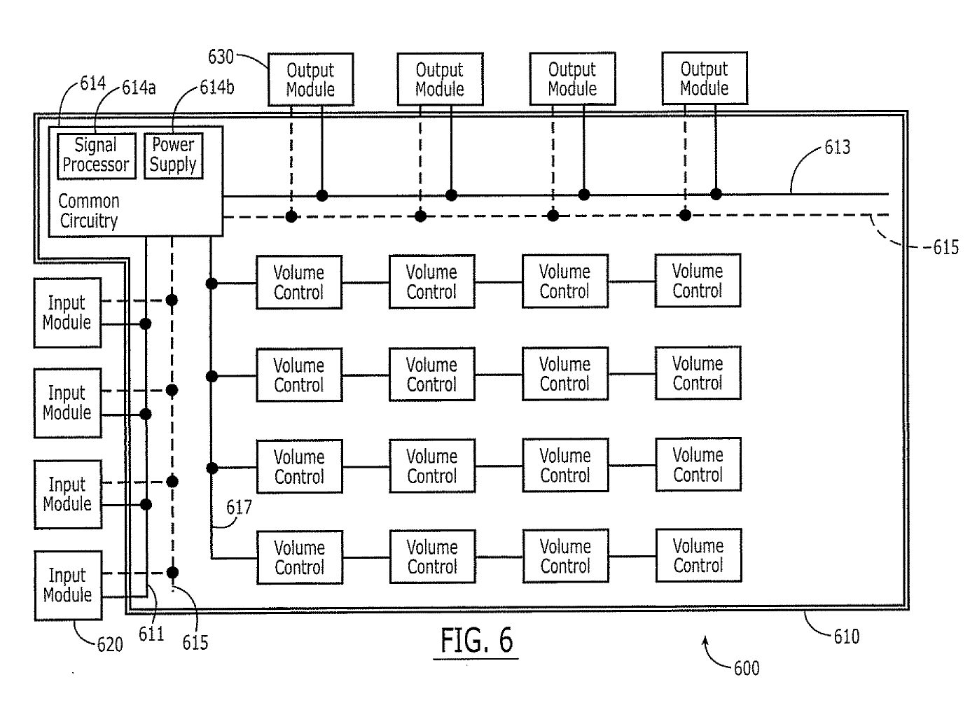

According further embodiments of the present invention, a digital mixer apparatus may be provided with a similar modular flexibility. Referring to FIG. 6, a mixer apparatus 600 includes a mixer module 610 that includes a digital input bus 611 configured to be coupled to audio input modules 620 to receive digital signals including audio content from devices coupled to the input modules 620, and a digital output bus 613 that is configured to be coupled to audio output modules 630 to provide digital signals including audio content to be conveyed to devices coupled to the output modules 630. The mixer module 610 further includes common circuitry 614 including a power supply 615b that provides power to the input modules 620 and/or the output modules 630 via a power bus 615, and a signal processor 615a that is configured to receive the digital input signals from the input modules 620 and to produce the digital output signals provided to the output modules 630. The signal processor 615a may be configured to provide audio mixing using content from the digital input signals to produce the digital output signals provided to the output modules 630.

It will be appreciated that, although FIG. 6 illustrates the provision of separate digital busses 611, 613 for input and output signals for the input and output modules 620, 630, in some embodiments, a common bus may be used for transfer of both input and output signals. It will also be appreciated that electrical, optical or other signal coupling may be provided between the input and output modules 620, 630 and the mixer module 610. In the illustrated embodiments, user input devices 612 are coupled to the common circuitry 614 (e.g., the signal processor 615b) to provide mixing control. It will also be appreciated that one or more discrete input devices, such as knobs or sliders, may be used to accept mixer control input, and some embodiments may be implemented using a simulation of such devices, such as one or more interactive icons provided on a computer screen and manipulable using a computer input device, such as a mouse, keyboard and/or touch screen.

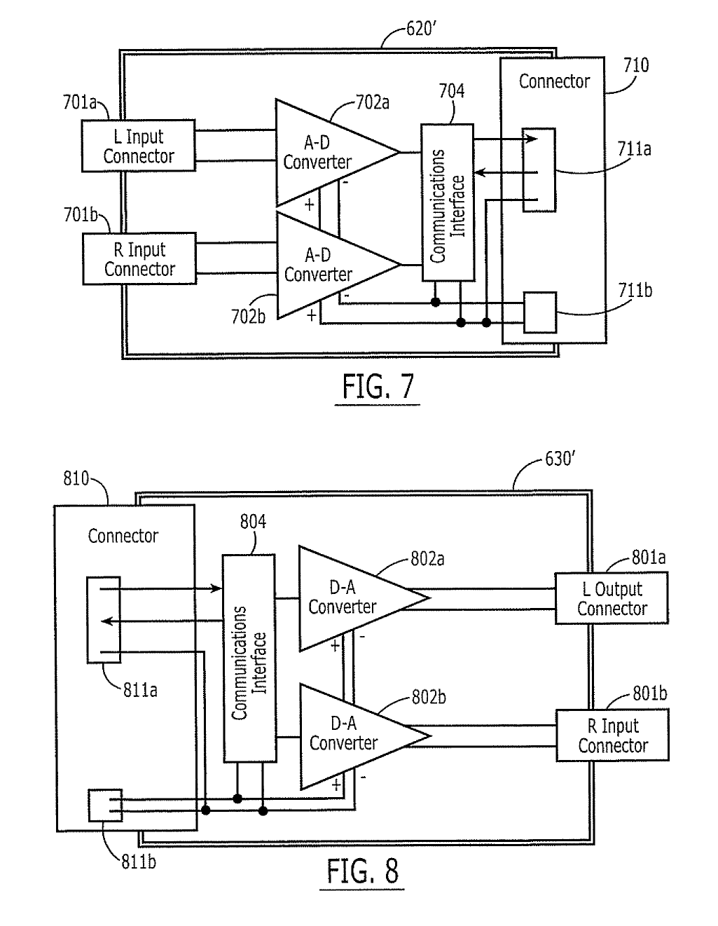

FIG. 7 illustrates an exemplary digital mixer input module 620′, e.g., a module for use in the mixer apparatus 600 of FIG. 6, according to some embodiments of the present invention. The module 620′ includes first and second (e.g., left and right channel stereo) input connectors 701a, 701b, which are connected to inputs of a first and second analog to digital converters 702a, 702b. It will be appreciated that the stereo connectors 701a, 701b are merely examples, and that a particular input module may have any of a number of different types of input connections depending on the type of device to which the input module 620′ is to be connected. In general, a given input module may support single and/or multiple channels, and may utilize any of a number of different types of connections, e.g., phono plugs of various sizes and configurations, RCA plugs, blade connectors, terminal strips, wire clamps and the like.

Outputs of the A/D converters 702a, 702b are connected to a communications interface circuit 704, to which the A/D converters 702a, 702b provide digital audio signals corresponding to analog audio signals provided to the input connectors 701a, 701b. The communications interface circuit 704 is, in turn, coupled to a connector 710 that is configured to mate with a base mixer module, e.g., the mixer module 610 of FIG. 6. As shown, the module connector 710 may include first pins, blades or other connector structures 711a configured to carry audio input signals produced by the communications interface circuit 704, and second pins, blades or other connector structures 711b configured to provide power connections for powering the A/D converters 702a, 702b and the communications interface circuit 704 from a power source in the mixer module.

Referring to FIG. 8, a digital mixer output module 630′ according to some embodiments of the present invention may be similarly configured. In particular, the output module 630′ may include a connector 810 that is configured to mate with a base mixer module, and includes first pins, blades or other connector structures 811a configured to provide digital signals including mixed audio content produced by the mixer module to a communications interface circuit 804, which provides the digital signals to analog (D/A) converters 802a, 802b. Second pins, blades or other connector structures 811b are configured to provide power connections for powering the D/A converters 802a, 802b and the communications interface circuit 804 from a power source in the mixer module. Analog audio outputs of the D/A converters 802a, 802b may be coupled to first and second output connectors 801a, 801b, which can be used to provide connection to an external device.

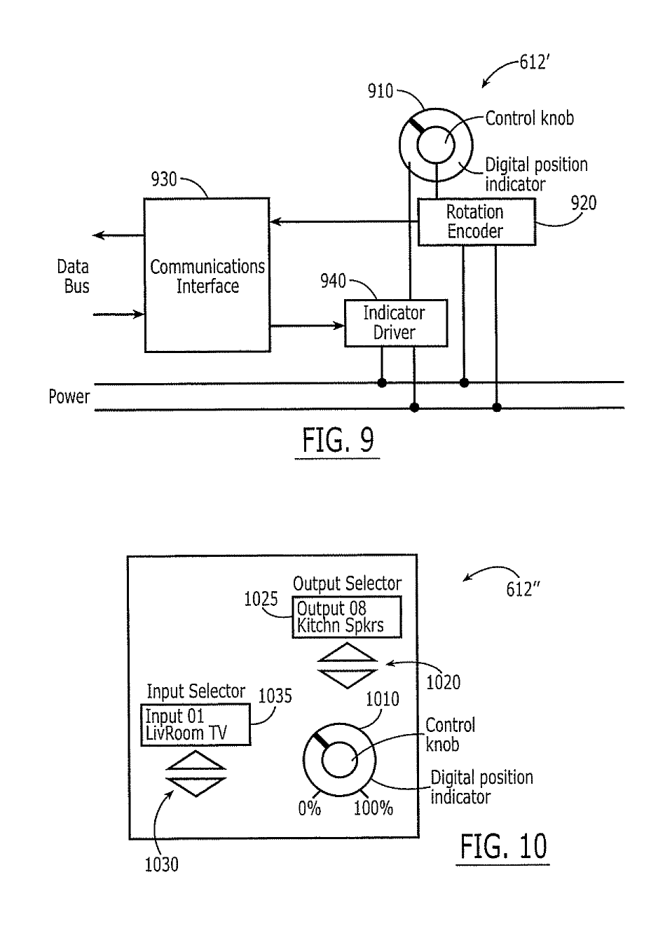

FIG. 9 illustrates a user input device 612′ that may be used with, for example, the mixer module 610 of FIG. 6. The user input device 612′ includes a control knob 910, which is mechanically coupled to a transducer, such as an encoder 920, that is configured to detect rotation of the control knob 910. The encoder 920 responsively provides an input to a communications interface circuit 930, which may be coupled to, for example, a processor of a mixer module, such as the mixer module 610 of FIG. 6, by a data bus, such as the input and output busses 611, 613 or a common bus that carries input and output signals. The communications interface circuit 930 may be further configured to receive signals from the mixer module processor which indicate the setting of the control knob 910, and which may be provided to an indicator 940 that provides visual or other feedback to a user.

As discussed above, mixer command inputs to a mixer apparatus according to embodiments of the present invention may be accepted using a variety of different types of user interfaces. For example, FIG. 10 illustrates a user input device 612″ in which mixing control of multiple output channels may be provided using a signal control knob 1010. Selectors 1020, 1030 may be provided to allow a user to select combinations of input and output channels (shown on displays 1025, 1035), such that the mixer knob 1010 may be used to control the amount of content from the selected input channel that is provided to the selected output channel.

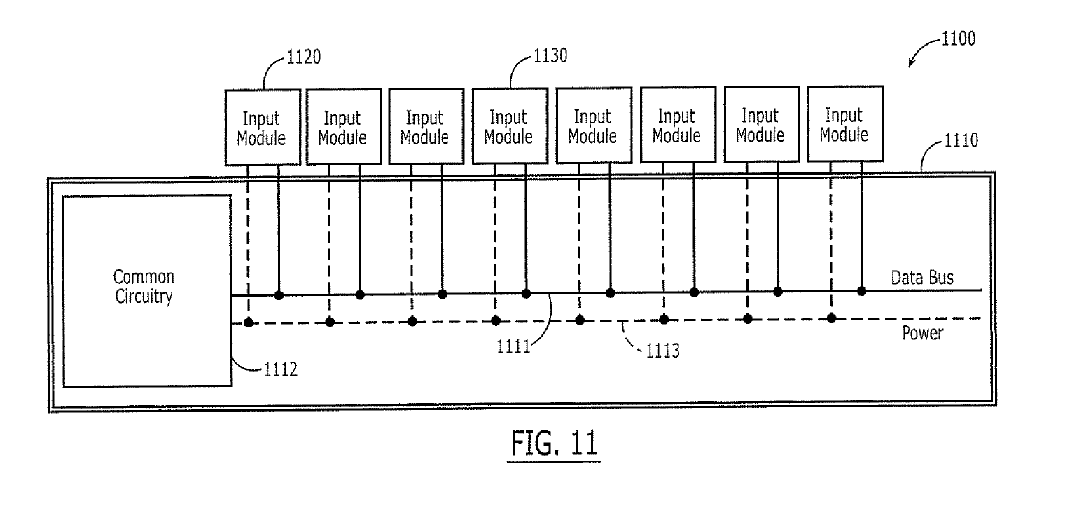

According to further embodiments of the present invention, enhanced expandability in a modular mixer apparatus may be provided by using a linear arrangement of input and output modules. For example, referring to FIG. 11, a modular mixer apparatus may include a digital mixer module 1110 including a data bus 1111 and power bus 1113 that connected to power and signal processing circuitry 1112. Input and output modules 1120, 1130 are mechanically supported along the length of the mixer module 1110, and are electrically coupled to the data bus 111 and the power bus 1113. The modules 1120, 1130 may have, for example, configurations along the lines described above with reference to FIGS. 7 and 8.

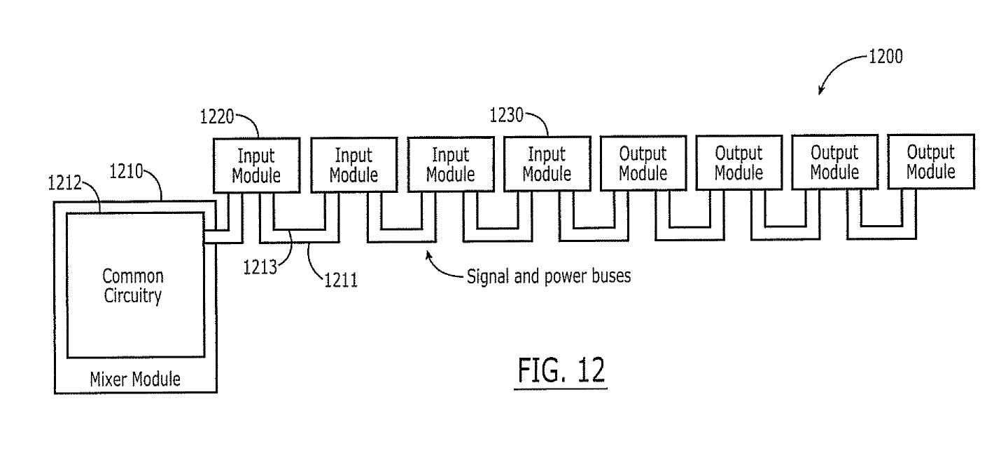

In additional embodiments of the present invention, a “daisy-chained” modular arrangement may be used. Referring to FIG. 12, a modular mixer apparatus 1200 according to some embodiments of the present invention includes a mixer module 1210 that includes common circuitry 1212, e.g., power and signal processing circuitry along the lines discussed above with reference to FIG. 6. Signal and power busses 1211, 1213 extend to a string of input and output modules 1220, 1230, to provide functionality similar to that described above with reference to FIG. 11.

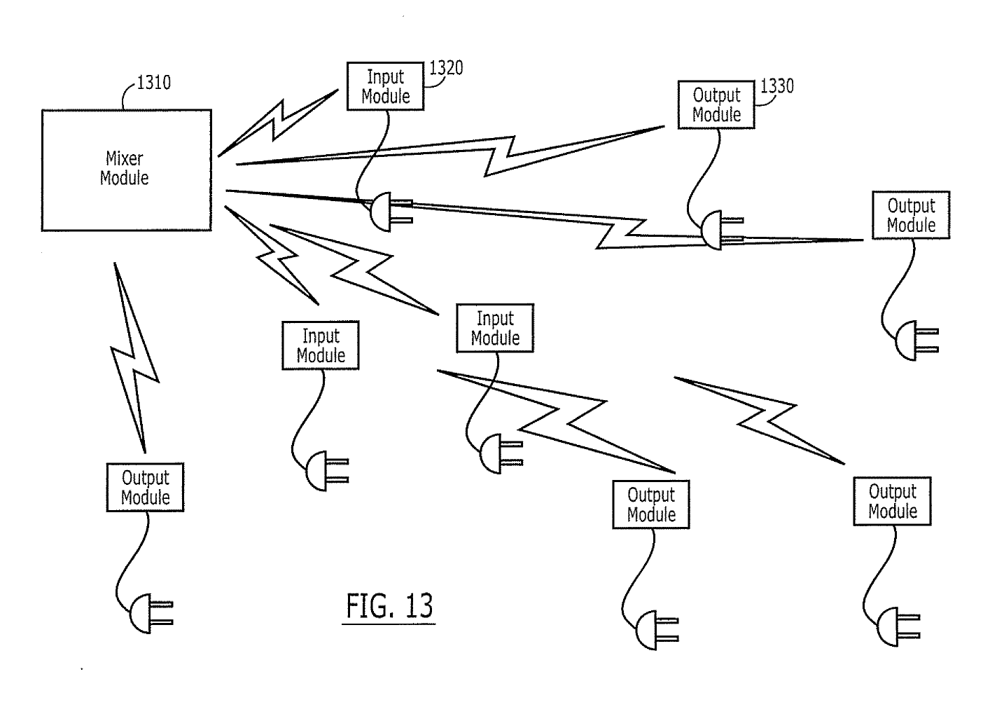

In yet further embodiments, a modular mixer apparatus may have a distributed structure in which a base mixer module is coupled to input and output modules using radio or other wireless links. Referring to FIG. 13, a modular mixer apparatus according to some embodiments of the present invention includes a base mixer module 1310 that includes a signal processor and radio interface circuits for communicating with input modules and output modules 1320, 1330. As shown, the input modules 1320 and output modules 1330 may be powered separately from the mixer module 1310.

In the drawings and specification, there have been disclosed embodiments of the invention and, although specific terms are employed, they are used in a generic and descriptive sense only and not for purposes of limitation, the scope of the invention being set forth in the following claims.

What is claimed:

1. An audio mixer module configured to receive audio input signals from audio input modules and to provide audio output signals to audio output modules, the audio mixer module configured to selectively mix the input audio signals to produce the respective audio output signals.

2. The audio mixer module of claim 1, configured to support wireless and/or wireline audio signal coupling with the audio input modules and/or the audio output modules.

3. The audio mixer module of claim 1, configured to mechanically support the audio input modules and/or the audio output modules.

4. The audio mixer module of claim 3, configured to attach audio input modules and audio output modules thereto along respective substantially orthogonal directions.

5. The audio mixer module of claim 3, configured to attach audio input modules and audio input modules thereto along a common direction.

6. The audio mixer module of claim 3, comprising a power supply circuit configured to be electrically coupled to audio input modules and/or the audio output modules attached thereto for provision of power to the audio input modules and/or audio output modules.

7. The audio mixer module of claim 1, wherein the audio mixer module is comprises a plurality of user input devices configured to receive respective mixer command inputs and arranged in a two-dimensional array, wherein respective ones of the user input devices control coupling between respective pairs of audio input and audio output modules.

8. The audio mixer module of claim 7, wherein the plurality of user input devices comprises a plurality of arrayed physical input devices and/or an array of input device representations depicted on a display.

9. The audio mixer module of claim 1, wherein the audio mixer module is configured to receive mixer command inputs from a remote user input device.

10. The audio mixer module of claim 1, wherein the audio mixer module is configured to provide analog and/or digital mixing of audio signals from the audio input modules.

11. An audio input module configured to interoperate with the audio mixer module of claim 1.

12. The audio input module of claim 11, comprising signal processing circuitry configured to convert audio input signals provided to the audio input module to a common audio input signal format used by the audio mixer module to communicate with audio input modules.

13. An audio output module configured to interoperate with the audio mixer module of claim 1.

14. The audio output module of claim 13, comprising signal processing circuitry configured to convert output signals from the audio mixer that conform to a common audio output signal format used by the audio mixer module to communicate with audio output modules to a signal format compatible with an external audio device.

15. A modular audio mixer system comprising the audio mixer module of claim 1 and at least one audio input module and/or audio output module.

16. A residential audio mixer system flexibly configurable to receive audio input signals from a variety of residential audio sources and flexibly configurable to provide audio output signals to a variety of residential audio output devices, the residential audio mixer configured to selectively mix the audio input signals to produce the respective audio output signal responsive to a mixer command input.

17. The system of claim 16, comprising a mixer module and a selection of audio input modules and/or audio input modules having various different external audio signal connection configurations and configured to interoperate with the mixer module.

18. The system of claim 16, wherein the mixer module is configured to electrically and/or optically couple to and mechanically support audio input modules and/or audio output modules.

19. The system of claim 16, wherein the audio input modules and/or the audio output modules comprise signal processing circuitry configured to convert between an external signal format and a common signal format used by the audio mixer module to communicate with audio input modules and/or audio output modules.
